(19) United States
(12) Patent Application Publication
(10) Pub. No.: US 2011/0055879 A1
(43) Pub. Date: Mar. 3, 2011

(54) PROCESSING, HANDLING, AND FORWARDING CONDITIONAL ACCESS MESSAGES TO DEVICES

(75) Inventors: Christopher J. Stone, Newtown, PA (US); Edmund S. Choromanski, Warrington, PA (US); Joseph F. Halgas, JR., Huntingdon Valley, PA (US); John P. Kamieniecki, Lafayette Hill, PA (US)

(73) Assignee: GENERAL INSTRUMENT CORPORATION, Horsham, PA (US)

(21) Appl. No.: 12/869,833

(22) Filed: Aug. 27, 2010

Related U.S. Application Data
(60) Provisional application No. 61/237,531, filed on Aug. 27, 2009.

(51) Int. Cl. H04N 7/18

(52) U.S. Cl. 725/82

(57) ABSTRACT

A computer-implemented method and system that configures a first DSG capable computing device that is connected to a home network, and includes a conditional access system that communicates data with the home network, and commits the first DSG capable computing device as a DSG proxy server. The method advertises DSG services to a second DSG capable computing device connected to the home network. The method establishes a tunnel for the second DSG capable computing device to filter DSG data for the second DSG capable computing device from the data, and forwards the DSG data to the second DSG capable computing device via the tunnel.

### RELATED APPLICATION

This application for letters patent relates to and claims the benefit of U.S. Provisional Patent Application Ser. No. 61/237,531 (Attorney's docket number BCS05829), titled “Processing, Handling, and Forwarding Conditional Access Messages to Devices”, and filed on Aug. 27, 2009; the disclosure of which this application hereby incorporates by reference.

### BACKGROUND

The OpenCable CableCARD Interface Specification defines the interface between a Host device (Host) and a CableCARD device (Card). The Host includes customer premises equipment (CPE), such as a set-top box, television, or digital video recorder (DVR). The Card provides the conditional access operation and the connectivity to the network for the Host.

The Data-Over-Cable Service Interface Specifications (DOCSIS) Set-top Gateway (DSG) Specification defines an interface and associated protocol that introduces additional requirements on a DOCSIS Cable Modem Termination System (CMTS) and DSG Cable Modem (CM) to support the configuration and transport of out-of-band (OOB) messages between a Set-top Controller (or application servers) and the CPE. Since the OOB messages include conditional access (CA) messages, the specification includes the current method for delivering CA messages to the Card.

Today, OpenCable specifications require that the Host operating in Quadrature Phase Shift Keying (QPSK) mode demodulate a QPSK radio frequency (RF) signal and forward the demodulated stream to the Card where the Card applies media access control (MAC) layer, link layer, moving picture experts group (MPEG), and private filtering to acquire the applicable CA messages. Likewise, OpenCable specifications require that the Host operating in DSG mode demodulate a DOCSIS RF signal and forward the Internet protocol (IP) stream to the Card where the Card applies IP, User Datagram Protocol (UDP), MPEG, and private filtering to acquire the applicable CA messages. All of this forwarding and filtering at various places creates a complex solution to a very simple problem. That is, the Card needs to receive the MPEG sections that contain the private CA messages without the burdens imposed by multiple layers of filtering.

There is a demand for a method and system for processing, handling, and forwarding DSG data to devices on a home network. The presently disclosed invention satisfies this demand.

### SUMMARY

Aspects of the present invention provide a computer-implemented method and system that configures a first DSG capable computing device that is connected to a home network, and includes a conditional access system that communicates data with the home network, and commits the first DSG capable computing device as a DSG proxy server. The method advertises DSG services to a second DSG capable computing device connected to the home network. The method establishes a tunnel for the second DSG capable computing device to filter DSG data for the second DSG capable computing device from the data, and forwards the DSG data to the second DSG capable computing device via the tunnel.

Aspects of the present invention also provide a computer-implemented method and system that commits a first DSG capable computing device connected to a home network as a DSG proxy client. The method receives DSG services from a second DSG capable computing device connected to the home network, where the second DSG capable computing device includes a conditional access system that communicates data with the home network. The method requests the establishment of a tunnel on the second DSG capable computing device to filter DSG data for the first DSG capable computing device from the data, and receives the DSG data from the second DSG capable computing device via the tunnel.

Aspects of the present invention also provide methods for processing, handling, and/or forwarding conditional access (CA) messages to devices, for example, that do not have a physical interface necessary to acquire the CA messages in their originally transmitted medium.

### BRIEF DESCRIPTION OF THE DRAWINGS

FIG. 1 is a network diagram that illustrates one embodiment of the hardware components of a system that performs the present invention.

FIG. 2 is a block diagram that illustrates, in detail, one embodiment of the hardware components shown in FIG. 1.

FIG. 3 and FIG. 4 are message flow diagrams that illustrate methods according to various embodiments of the present invention.

### DETAILED DESCRIPTION

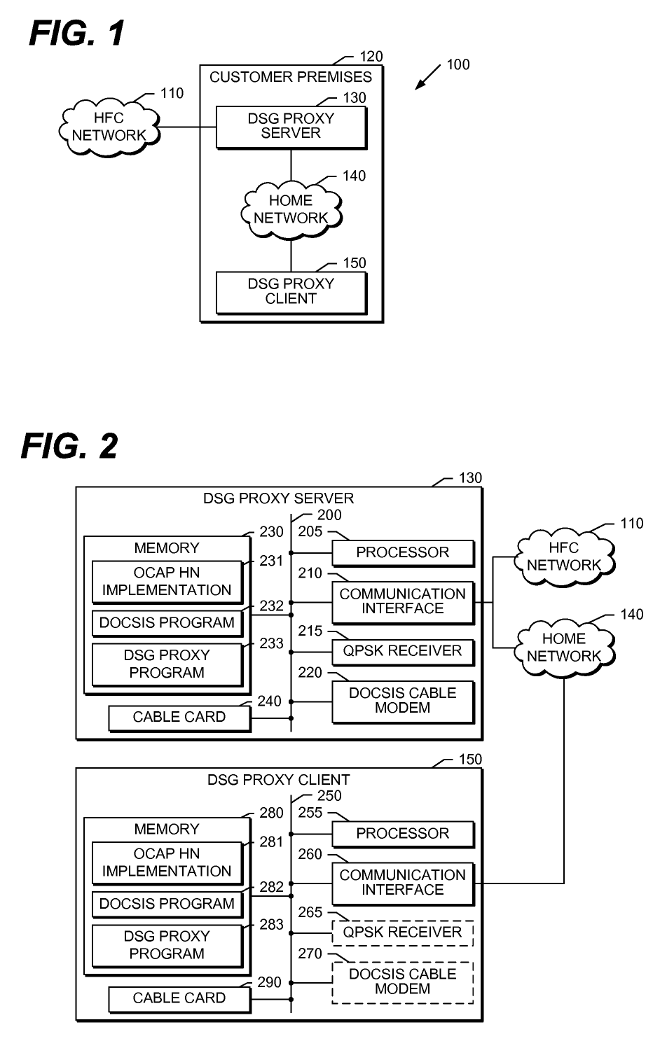

FIG. 1 is a network diagram that illustrates one embodiment of the hardware components of a system that performs the present invention. A home networking system 100 includes a hybrid fiber-coaxial (HFC) network 110, and customer premises 120, which includes a Data-Over-Cable Service Interface Specifications (DOCSIS) Set-top Gateway (DSG) proxy server 130, home network 140, and DSG proxy client 150. The DSG proxy server 130 connects to the HFC network 110, and the home network 140. The DSG proxy client 150 connects to the home network 140. The DSG proxy server 130 is a DSG capable device, that is, a device that includes DOCSIS hardware. The DSG proxy server 130 receives data and video content from the HFC network 110 and distributes the data and video content to the DSG proxy client 150 via the home network 140. In one embodiment, the DSG proxy client 150 acquires video content directly from the HFC network 110, and only uses the home network 140 and DSG proxy server 130 to acquire data. In various embodiments, the DSG proxy server 130 is a set-top box, television, digital video recorder (DVR), standalone cable modem router/gateway, or the like. In various embodiments, the DSG proxy client 150 is a set-top box, television, digital video recorder (DVR), or the like. The home networking system 100 shown in FIG. 1 may include any number of interconnected HFC networks 110, DSG proxy servers 120, home networks 130, and DSG proxy clients 140.

The HFC network 110 shown in FIG. 1, in one embodiment, is a broadband network that combines optical fiber and coaxial cable, technology commonly employed globally by cable television operators since the early 1990s. The fiber optic network extends from the cable operators master head end, sometimes to regional head ends, and out to a neighborhood hubsite, and finally to a fiber optic node that serves anywhere from 25 to 2000 homes. The master head end will usually have satellite dishes for reception of distant video signals as well as IP aggregation routers. Some master head ends also house telephony equipment for providing telecommunications services to the community. The regional head ends receive the video signal from the master head end and add to it the Public, Educational and/or Governmental (PEG) channels as required by local franchising authorities or insert targeted advertising that would appeal to the region. The various services are encoded, modulated and up-converted onto RF carriers, combined onto a single electrical signal and inserted into a broadband optical transmitter. This optical transmitter converts the electrical signal to a downstream optically modulated signal that is sent to the nodes. Fiber optic cables connect the head end to optical nodes in a point-to-point or star topology, or in some cases, in a protected ring topology.

The home network 140 shown in FIG. 1, in one embodiment, is a private communication network. The present invention also contemplates the use of comparable network architectures. Comparable network architectures include a LAN, a Personal Area Network (PAN) such as a Bluetooth network, a wireless LAN (e.g., a Wireless-Fidelity (Wi-Fi) network), and a Virtual Private Network (VPN). The system also contemplates network architectures and protocols such as Ethernet, Internet Protocol, and Transmission Control Protocol. In various embodiments, the home network 140 will support a variety of network interfaces, including 802.3ab/u/etc., Multimedia over Coax Alliance (MoCA), and 801.11.

FIG. 2 is a block diagram that illustrates, in detail, one embodiment of the hardware components shown in FIG. 1. In particular, FIG. 2 illustrates the hardware components and software comprising the DSG proxy server 130 and DSG proxy client 150 shown in FIG. 1.

The DSG proxy server 130, in one embodiment, comprises a general-purpose computing device that performs the present invention. A bus 200 is a communication medium that connects a processor 205, communication interface 210, quadrature phase shift keying (QPSK) receiver 215, DOCSIS cable modem 220, memory 230 (such as Random Access Memory (RAM), Dynamic RAM (DRAM), non-volatile computer memory, flash memory, or the like), and cable card 240 (such as an OpenCable CableCARD). The processor 205, in one embodiment, is a central processing unit (CPU). The communication interface 210 connects the DSG proxy server 130 to the HFC network 110 and home network 140. The cable card 240 shown in FIG. 2 is a physical device that provides the DSG proxy server 130 with conditional access to the HFC network 110 and home network 140; however, the present invention contemplates the DSG proxy server 130 using other conditional access system solutions, such as Downloadable Conditional Access System (DCAS), embedded security, or the like. In one embodiment, the implementation of the DSG proxy server 130 is an application-specific integrated circuit (ASIC). In another embodiment, the DSG proxy server 130 includes a data storage device (not shown), such as a Serial ATA (SATA) hard disk drive, optical drive, Small Computer System Interface (SCSI) disk, flash memory, or the like.

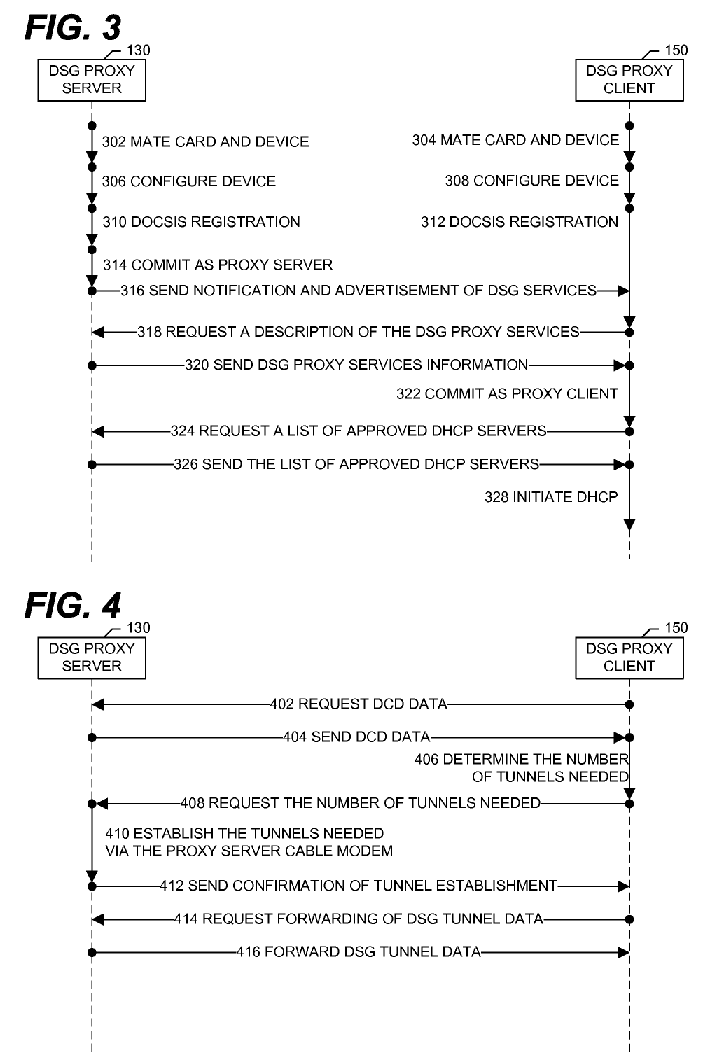

The processor 205 performs the disclosed methods by executing the sequences of operational instructions that comprise each computer program resident in, or operative on, the memory 230. The reader should understand that the memory 230 may include operating system, administrative, and database programs that support the programs disclosed in this application. In one embodiment, the configuration of the memory 230 of the DSG proxy server 130 includes an OCAP HN implementation 231, DOCSIS program 232, and DSG proxy program 233. The OCAP HN implementation 231, DOCSIS program 232, and DSG proxy program 233 perform the methods of the present invention disclosed in detail in FIG. 3 and FIG. 4. When the processor 205 performs the disclosed methods, it stores intermediate results in the memory 230 or a data storage device (not shown). In another embodiment, the memory 230 may swap these programs, or portions thereof, in and out of the memory 230 as needed, and thus may include fewer than all of these programs at any one time.

The DSG proxy client 150, in one embodiment, comprises a general-purpose computing device that performs the present invention. A bus 250 is a communication medium that connects a processor 255, communication interface 260, memory 280 (such as Random Access Memory (RAM), Dynamic RAM (DRAM), non-volatile computer memory, flash memory, or the like), and cable card 290 (such as an OpenCable CableCARD). Optionally, the bus 250 may also connect a quadrature phase shift keying (QPSK) receiver 265, and DOCSIS cable modem 270. The processor 255, in one embodiment, is a central processing unit (CPU). The communication interface 260 connects the DSG proxy client 150 to the home network 140. The cable card 290 shown in FIG. 2 is a physical device that provides the DSG proxy client 150 with conditional access to the HFC network 110 and home network 140; however, the present invention contemplates the DSG proxy client 150 using other conditional access system solutions, such as Downloadable Conditional Access System (DCAS), embedded security, or the like. In one embodiment, the implementation of the DSG proxy client 150 is an application-specific integrated circuit (ASIC). In another embodiment, the DSG proxy client 150 includes a data storage device (not shown), such as a Serial ATA (SATA) hard disk drive, optical drive, Small Computer System Interface (SCSI) disk, flash memory, or the like.

The processor 255 performs the disclosed methods by executing the sequences of operational instructions that comprise each computer program resident in, or operative on, the memory 280. The reader should understand that the memory 280 may include operating system, administrative, and database programs that support the programs disclosed in this application. In one embodiment, the configuration of the memory 280 of the DSG proxy client 150 includes an OCAP HN implementation 281, DOCSIS program 282, and DSG proxy program 283. The OCAP HN implementation 281, DOCSIS program 282, and DSG proxy program 283 perform the methods of the present invention disclosed in detail in FIG. 3 and FIG. 4. When the processor 255 performs the disclosed methods, it stores intermediate results in the memory 280 or a data storage device (not shown). In another embodiment, the memory 280 may swap these programs, or portions thereof, in and out of the memory 280 as needed, and thus may include fewer than all of these programs at any one time.

In one embodiment, the DSG proxy server 130 is an OpenCable Host Device equipped with a DOCSIS cable modem 220 that is capable of providing DSG services to other OpenCable Host devices, DSG proxy clients 150 that connect to the DSG proxy server 150 via a home network 140. The DSG services include bi-directional IP connectivity (i.e., the DOCSIS cable modem 220 in the DSG proxy server 130 is exposing it's upstream/downstream DOCSIS resource allowing the connected DSG proxy clients 150 to obtain access to the service provider's DOCSIS network). All other DSG specific data (e.g., conditional access (CA) Tunnels, Application Tunnels and Broadcast Tunnels) are acquired directly using the DOCSIS cable modem 270 of the DSG proxy client 150, configured to operate in a DSG One-Way mode, thus the RF transmitter (not shown) is not active. Thus, the DSG proxy server 130 provides Internet protocol (IP) connectivity to the service provider's DOCSIS network, and forwarding of DSG Tunnel Data to the home network 140.

The DSG proxy server 130 and the DSG proxy client 150 are both DSG devices. In various embodiments, these DSG devices will support the following high-level design constraints to support the DSG proxy solution of the present invention.
(1) When the DSG proxy client 150 fails to complete DOCSIS registration, it attempts to locate and utilize a DSG proxy server 130 for its non-DSG Internet protocol (IP) traffic (e.g., bi-directional IP unicast traffic). All DSG traffic (e.g., conditional access (CA) Tunnels, Application Tunnels and Broadcast Tunnels) is consumed by the DOCSIS cable modem 270 of the DSG proxy client 150 (as if the device was operating in DSG one-way mode).
(2) The DSG proxy client 150 does not forward any DSG traffic to the home network 140.
(3) The DOCSIS cable modem 220 of the DSG proxy server 130 is only accessible by a DSG proxy client 150 on the home network 140. Personal computers, gaming consoles, and other non-OpenCable IP devices, are not allowed access to the HFC network 110 via the DOCSIS cable modem 220 of the DSG proxy server 130. Therefore, the DSG proxy server 130 must drop all packets received on its home network 140 communication interface 210 not addressed with a media access control (MAC) address of a known DSG proxy client 150.
(4) The DSG proxy client 150 must be addressed in the same address space as the DSG proxy server 130 such that the DSG proxy client 150 can successfully communicate with the conditional access system for the service provider associated with the HFC network 110, video-on-demand (VOD) servers, etc. As a result the solution must be such that the DSG proxy client 150 receives its IP address from the same source as the DSG proxy server 130 (i.e., the Dynamic Host Configuration Protocol (DHCP) server in the headend for the service provider).
(5) Any DSG device that is able to complete DOCSIS provisioning will use its embedded cable modem (eCM) for provisioning of the embedded set-top box (eSTB) and CableCARD (as applicable). If the device completes DOCSIS registration and does not commit to the role of DSG proxy server 130 (e.g., a DSG proxy server 130 already resides on the home network), then the device does not act as a DSG proxy client 150.
(6) Once a DSG device provisions as a DSG proxy client 150, it does not attempt any further DOCSIS registration until such time as it loses connection with the DSG proxy server 130 and is not able to locate a replacement DSG proxy server 130.

In various other embodiments, these DSG devices will support the following additional high-level design constraints to support the forwarding of DSG Tunnel Data for the DSG proxy solution of the present invention.
(1) The DSG proxy server 130 provides the ability to forward DSG Tunnel Data to the DSG proxy client 150 devices residing on the home network 140.
(2) The DSG proxy client 150 is able to acquire DSG Tunnel Data from the DSG proxy server 130 via the home network 140. Thus, if the DSG proxy client 150 includes the optional DOCSIS cable modem 270, this ability allows the DSG proxy client 150 to completely disable its DOCSIS cable modem 270 (which is beneficial for energy conservation initiatives).
(3) The DSG proxy client 150 determines if the DSG proxy server 130 supports the forwarding of DSG Tunnel Data by issuing a request for Downstream Channel Descriptor (DCD) data. If the DSG proxy server 130 rejects the request indicating that DSG Tunnel Data forwarding is not supported, then the DSG proxy client 150 is not able to acquire the DSG Tunnel Data from the DSG proxy server 130 and must use its DOCSIS cable modem 270 to acquire the data. If the DSG proxy server 130 responds providing the DCD data, then the DSG proxy client 150 is able to acquire DSG Tunnel Data from the DSG proxy server 130 and proceeds as described herein.

The DSG proxy service of the presently disclosed invention provides control for establishing IP connectivity between the DSG proxy server 130 and the DSG proxy client 150 on the home network 140. The DSG proxy service provides IP connectivity to the DSG proxy client 150 via the service provider's DOCSIS network. In addition, the DSG proxy service, when supported by the DSG proxy server 130 and DSG proxy client 150, (1) requesting and forwarding DSG Tunnel Data to the DSG proxy client 150 residing on the home network 140; (2) notification that the DSG proxy client 150 has left the home network 140 and allows the DSG proxy server 130 to determine if it still needs to continue to forward DSG Tunnel Data; and (3) querying of DCD information. The DSG proxy service does not enable control of the DSG Client Controller in the DSG proxy server 130. The DSG Client Controller in the DSG proxy server 130 makes all decisions regarding the acceptance of a DOCSIS downstream containing the applicable DSG Tunnels. The DSG proxy client 150, and likewise the DSG Client Controllers residing therein, is dependent on the DSG proxy server 130 for making the correct choice of DOCSIS downstream channels.

To allow that the DSG proxy client 150 on the home network 140 to get an IP address via proxy through the DSG proxy server 130, and not some other DHCP server that may be residing on the home network 140, the DSG proxy server 130 provides the DSG proxy client 150 with a list of approved DHCP servers. The DSG proxy server 130 acquires the list of approved DHCP servers from the TLV217 encoding of the DOCSIS cable modem 220 configuration file in the DSG proxy server 130. The DSG proxy server 130 acquires the list of approved DHCP servers from the DSG proxy client 150 via request. If the DOCSIS cable modem 220 configuration file in the DSG proxy server 130 does not define any approved DHCP servers, then the DSG proxy server 130 returns a null value to the DSG proxy client 150, indicating that the DSG proxy client 150 can take an IP address from any DHCP server.

Since the DSG proxy client 150 does not utilize DHCP until it has acquired the list of approved DHCP servers, the DSG proxy client 150 utilizes link-local addressing as per [RFC 3927] for the DSG proxy provisioning. Universal Plug and Play (UPnP) defines that link-local is to be used when DHCP addressing fails, however in this case, since the DSG proxy client 150 is not using DHCP until after it acquires the list of approved DHCP servers, link-local needs to used out of the gate until such time as the DSG proxy client 150 acquires the list of approved DHCP servers and acquires an IP address from an approved DHCP server. As such, the DSG proxy server 130 maintains its link-local address to facilitate the provisioning of new DSG proxy clients 150 that enter the home network 140.

In one embodiment, the DSG proxy service includes the forwarding of DSG Tunnel Data, to provide a means to support DSG capable devices that may have issues with their DOCSIS downstream or for other devices, such as the DSG proxy client 150, that do not even have DOCSIS modems, but have the capability to acquire and process the DSG data. If within the home both the DSG proxy client 150 and the DSG proxy server 130 support the forwarding of DSG Tunnel Data, then the DSG proxy client 150 may request the forwarding of said data from the DSG proxy server 130.

In one embodiment, the forwarding of DSG Tunnel Data to the home network interface is accomplished using Internet Protocol Security (IPsec) [RFC 4301] and Encapsulating Security Payload (ESP) [RFC 4303], which operates in Tunnel mode (the IPsec optional Authentication Header (AH) is not utilized). The encryption mode utilized is AES-CBC [RFC 4835] and [RFC 3602], with a 128-bit symmetric key. The ESP packet is then multicast on the home network 140, utilizing an IP multicast address and UDP ports defined by the DSG proxy server 130. All of the DSG Tunnel Data that is delivered to the home network 140 is encapsulated in a single ESP Tunnel, thus creating a pseudo-VPN within the home network for delivery of the DSG Tunnel Data. Encrypting the entire DSG packet ensures that the DSG tunnel filtering information (i.e., the IP addresses and UDP ports) is not altered while being delivered on the home network 140 communications interface 210, in addition to providing security for the protection of the data contained within the DSG tunnels.

The 128-bit key is generated and managed by the DSG proxy server 130 in a simple fashion; the DSG proxy server 130 generates the key by using a pseudo-random number generator, provides the key to the DSG proxy client 150 via request using a UPnP action over a Transport Layer Security (TLS) connection, thus providing security for the transfer of the key. In another embodiment, the DSG proxy server 130 generates the 128-bit key using crypto-key processes well-known to those skilled in the art. The DSG proxy server 130 refreshes the key whenever it reboots or when it takes on the role of the DSG proxy server 130.

FIG. 3 is a message flow diagram that illustrates methods according to various embodiments of the present invention. In particular, FIG. 3 illustrates the initial discovery and configuration process between the DSG proxy server 130, and DSG proxy client 150.

The initial discovery and configuration process shown in FIG. 3, with reference to FIG. 1 and FIG. 2, begins when the DSG proxy server 130 mates with its cable card 240 (step 302), and the DSG proxy client 150 mates with its cable card 290 (step 304).

After the mating of the cable card (240, 290) and the DSG device (130, 150), the process shown in FIG. 3 configures the DSG proxy server 130 (step 306) and the DSG proxy client 150 (step 308). In one embodiment, the configuration enables two-way DSG mode for the DSG proxy server 130 and DSG proxy client 150. All of the devices residing on the home network 140 will boot-up, initialize, and attempt to provision, but only one device will assume the role of DSG proxy server 130, while the other devices will assume the role of DSG proxy client 150.

The process shown in FIG. 3 illustrates an embodiment of initial discovery in which there is no contention between the DSG proxy server 130 and the DSG proxy client 150. The DSG proxy server 130 begins DOCSIS registration (step 310) at the same time that the DSG proxy client 150 begins DOCSIS registration (step 312). When the DOCSIS registration completes, the DSG proxy server 130 commits as proxy server (step 314) and send a notification and advertisement of DSG services (step 316) to the DSG proxy client 150, and all other devices on the home network 140, before the DOCSIS registration completes on the DSG proxy client 150. In another embodiment, the DOCSIS registration for the devices on the home network 140 creates contention between two or more of the devices for the role of DSG proxy server 130; however, only one of the devices will assume the role of DSG proxy server 130. In yet another embodiment, periodic contention tests detect and resolve contention that occurs between two or more devices on the home network 140 due to a device abdicating its role as DSG proxy server 130.

When the DSG proxy client 150 completes DOCSIS registration (step 312), it recognizes that it has received a notification and advertisement of DSG services (step 316) from the DSG proxy server 130. The DSG proxy client 150 sends a request for a description of the DSG proxy services (step 318) to the DSG proxy server 130. The DSG proxy server 130 responds by sending DSG proxy services information (step 320) to the DSG proxy client 150. Upon receipt of the DSG proxy services information, the DSG proxy client 150 commits as a proxy client (step 322). The DSG proxy client 150 requests the IP address mode and a list of approved DHCP servers from the DSG proxy client 130 (step 324). In response, the DSG proxy server 130 provides the IP address mode in which it is operating (IPv4, IPv6, or the like), and the list of approved DHCP servers (step 326). The DSG proxy client 150 initiates DHCP (step 328) in an effort to acquire an IP address, and receive offers/solicits from DHCP servers.

In another embodiment of the process shown in FIG. 3, the Card (cable card 240, cable card 290) uses the extended channel to open a DSG Flow with its Host (DSG proxy server 130, DSG proxy client 150). The Host responds to the Card and provides the Card with a flow ID. At this point, the Card ceases to communicate on the extended channel of the Card/Host interface, and forces itself into a DSG one-way like mode (i.e., does not attempt to open any IP flow), and waits for conditional access system control messages to be delivered over the extended channel via the DSG Flow.

Since, today, the Host has the ability to communicate with the Card using either the QPSK receiver (215, 265) or the DOCSIS cable modem (220, 270), the Card determines whether it should be operating in QPSK mode or DSG mode. If the reportback path is such that the Host uses the QPSK OOB for the forward data channel, then the Host will use a well-known method to rebuild the sections, encapsulate the sections in a DSG packet, and send the packet to the Card over the DSG Flow. If the reportback path and configuration is such that the Host uses DSG to deliver conditional access (CA) system messages, then the Host will use a well-known method to send the applicable messages associated with the CA tunnel to the Card in a DSG packet via the DSG Flow. If the reportback path and configuration is such that the conditional access system delivers messages utilizing MPEG packets encapsulated in UDP, then the Host will use a well-known method to rebuild the sections, encapsulate the sections in a DSG packet, and send the packet to the Card over the DSG Flow. Any messages that should be reported back via the Card are handled via the Host, where the messages are delivered to the Host via the Card utilizing the Specific Application Support (SAS) resource. In this scenario, the Host uses the applicable protocol to report back to the conditional access system based on the configuration of the Host. If the Host is configured as anything other than DOCSIS, the Host uses the QPSK return path. If the Host is configured as a DOCSIS device, the Host uses the DOCSIS return path. Conditional access system messages that receive support from the Card are handled via the SAS where the Host requests the Card to construct the applicable conditional access system message and relay the message to the Host via the SAS resource. The Host then encapsulated the conditional access system message in the applicable reportback protocol and transmits to the DAC/RADD (Digital Addressable Controller/Remote Addressable DANIS/DLS (Downloadable Addressable Network Interface System/Download Server)) over the applicable interface (i.e., QPSK or DOCSIS).

FIG. 4 is a message flow diagram that illustrates methods according to various embodiments of the present invention. In particular, FIG. 4 illustrates the process to establish DSG tunnels, acquire addresses, and forward DSG tunnel data between the DSG proxy server 130, and DSG proxy client 150.

The process to establish DSG tunnels, acquire addresses, and forward DSG tunnel data between the DSG proxy server 130, and DSG proxy client 150 shown in FIG. 4, with reference to FIG. 1 and FIG. 2, begins when the initial discovery and configuration process shown in FIG. 3 completes.

The DSG proxy client 150 sends a request for DCD data to the DSG proxy server 130 (step 402). The DSG proxy server 130, which supports the forwarding of DSG tunnel data to the home network 140, responds by sending the DCD data to the DSG proxy client 150 (step 404). The DSG proxy client 150 uses the DCD data to determine the number of tunnels it needs (step 406). For example, if the DSG proxy client 150 needs two (2) CA tunnels, one (1) application tunnel, and one (1) broadcast tunnel, then the DSG proxy client 150 will send a request to the DSG proxy server 130 for four (4) unique tunnels (step 408). The DSG proxy server 130 establishes the number of tunnels requested (in one embodiment, IP tunnels) via its DOCSIS cable modem 220 (step 410), and sends confirmation of the establishment of the tunnels to the DSG proxy client 150 (step 412). In one embodiment, the confirmation includes the IP multicast destination address, IP source address, UDP source and destination ports, and a key to decrypt the DSG tunnel data. The DSG proxy client 150 sends a request to begin the forwarding of the DSG tunnel data (step 414) to prompt the DSG proxy client to forward the DSG tunnel data (step 416).

A benefit of the processes shown in FIG. 3 and FIG. 4 is to provide a single solution for the Card, and eliminate the necessity to have multiple ways to transmit conditional access system messages to the Card based on the mode of operation. In one embodiment of the processes shown in FIG. 3 and FIG. 4, the DSG proxy server 130 is a “master” set-top box (STB) operating on the home network 140 that acquires conditional access (CA) data via whatever means (e.g., QPSK, DSG, or the like) and proxy this data to the DSG proxy clients 150 on the home network 140 by converting the data into a single well-defined format. Thus, a single data flow type across the Card/Host interface and/or the home network 140 where the Host/STBs can process all incoming messages from any of the many RF/IP/other physical interfaces that it has and send a single well-known stream/data type to the Card and/or DSG proxy clients 150 on the home network 140. With the introduction of home networking and the processes shown in FIG. 3 and FIG. 4, it is possible to remove the PHY/MAC layer on the DSG proxy clients 150 and utilize a common solution for delivering CA data to the DSG proxy clients 150.

Although the disclosed embodiments describe a fully functioning method and system for processing, handling, and forwarding DSG data to devices on a home network, the reader should understand that other equivalent embodiments exist. Since numerous modifications and variations will occur to those reviewing this disclosure, the method and system for processing, handling, and forwarding DSG data to devices on a home network is not limited to the exact construction and operation illustrated and disclosed. Accordingly, this disclosure intends all suitable modifications and equivalents to fall within the scope of the claims.

We claim:

1. A computer-implemented method, comprising:
configuring a first DSG capable computing device, wherein the first DSG capable computing device is connected to a home network, and includes a conditional access system that communicates data with the home network;
committing the first DSG capable computing device as a DSG proxy server;
advertising DSG services to a second DSG capable computing device connected to the home network;
establishing a tunnel for the second DSG capable computing device to filter DSG data for the second DSG capable computing device from the data; and
forwarding the DSG data to the second DSG capable computing device via the tunnel.

2. The computer-implemented method of claim 1, wherein the conditional access system is a CableCARD, and wherein the configuring of the first DSG capable computing device further comprises:
mating the CableCARD with the first DSG capable computing device.

3. The computer-implemented method of claim 1, wherein the committing of the first DSG capable computing device further comprises:
completing DOCSIS registration of the first DSG capable computing device.

4. The computer-implemented method of claim 1, wherein the advertising of the DSG services further comprises:
sending a notification to the second DSG capable computing device that the DSG services are available; and
sending a description of the DSG services to the second DSG capable computing device;

5. The computer-implemented method of claim 4, further comprising:
receiving a request for the DSG services from the second DSG capable computing device.

6. The computer-implemented method of claim 1, wherein the second DSG capable computing device is a DSG proxy client.

7. The computer-implemented method of claim 1, wherein the establishing of the tunnel further comprises:
sending DCD data to the second DSG capable computing device to confirm support of DSG data forwarding; and
receiving a request to establish the tunnel.

8. The computer-implemented method of claim 1, wherein the DSG data includes conditional access messages.

9. The computer-implemented method of claim 1, further comprising:
sending a list of approved DHCP servers for the home network to the second DSG capable computing device.

10. A system, comprising:
a memory device resident in a first DSG capable computing device; and
a processor disposed in communication with the memory device, the processor configured to:
configure the first DSG capable computing device, wherein the first DSG capable computing device is connected to a home network, and includes a conditional access system that communicates data with the home network;
commit the first DSG capable computing device as a DSG proxy server;
advertise DSG services to a second DSG capable computing device connected to the home network;
establish a tunnel for the second DSG capable computing device to filter DSG data for the second DSG capable computing device from the data; and
forward the DSG data to the second DSG capable computing device via the tunnel.

11. The system of claim 10, wherein the conditional access system is a CableCARD, and wherein to configure the first DSG capable computing device, the processor is further configured to:
mate the CableCARD with the first DSG capable computing device.

12. The system of claim 10, wherein to commit the first DSG capable computing device, the processor is further configured to:
complete DOCSIS registration of the first DSG capable computing device.

13. The system of claim 10, wherein to advertise the DSG services, the processor is further configured to:
send a notification to the second DSG capable computing device that the DSG services are available; and
send a description of the DSG services to the second DSG capable computing device.

14. The system of claim 13, wherein the processor is further configured to:
receive a request for the DSG services from the second DSG capable computing device.

15. The system of claim 10, wherein the second DSG capable computing device is a DSG proxy client.

16. The system of claim 10, wherein to establish the tunnel, the processor is further configured to:
send DCD data to the second DSG capable computing device to confirm support of DSG data forwarding; and
receive a request to establish the tunnel.

17. The system of claim 10, wherein the DSG data includes conditional access messages.

18. The system of claim 10, wherein the processor is further configured to:
sending a list of approved DHCP servers for the home network to the second DSG capable computing device.

19. A non-transitory computer-readable medium, comprising computer-executable instructions that, when executed on a first DSG capable computing device, perform steps of:
configuring the first DSG capable computing device, wherein the first DSG capable computing device is connected to a home network, and includes a conditional access system that communicates data with the home network;
committing the first DSG capable computing device as a DSG proxy server;
advertising DSG services to a second DSG capable computing device connected to the home network;
establishing a tunnel for the second DSG capable computing device to filter DSG data for the second DSG capable computing device from the data; and
forwarding the DSG data to the second DSG capable computing device via the tunnel.

20. A computer-implemented method, comprising:
committing a first DSG capable computing device connected to a home network as a DSG proxy client;
receiving DSG services from a second DSG capable computing device connected to the home network, wherein the second DSG capable computing device includes a conditional access system that communicates data with the home network;
requesting establishment of a tunnel on the second DSG capable computing device to filter DSG data for the first DSG capable computing device from the data; and
receiving the DSG data from the second DSG capable computing device via the tunnel.

21. The computer-implemented method of claim 20, wherein the committing of the first DSG capable computing device further comprises:
completing DOCSIS registration of the first DSG capable computing device.

22. The computer-implemented method of claim 20, wherein the receiving of the DSG services further comprises:
receiving a notification from the second DSG capable computing device that the DSG services are available; and
receiving a description of the DSG services from the second DSG capable computing device.

23. The computer-implemented method of claim 22, further comprising:
sending a request for the DSG services to the second DSG capable computing device.

24. The computer-implemented method of claim 20, wherein the second DSG capable computing device is a DSG proxy server.

25. The computer-implemented method of claim 20, wherein the requesting of the establishment of the tunnel further comprises:
requesting DCD data to confirm that the second DSG capable computing device supports DSG data forwarding; and
receiving confirmation from the second DSG capable computing device of the establishment of the tunnel.

26. The computer-implemented method of claim 20, wherein the DSG data includes conditional access messages.

27. The computer-implemented method of claim 20, further comprising:
receiving a list of approved DHCP servers for the home network from the second DSG capable computing device.

28. A system, comprising:
a memory device resident in a first DSG capable computing device; and
a processor disposed in communication with the memory device, the processor configured to:
commit the first DSG capable computing device connected to a home network as a DSG proxy client;
receive DSG services from a second DSG capable computing device connected to the home network, wherein the second DSG capable computing device includes a conditional access system that communicates data with the home network;
request establishment of a tunnel on the second DSG capable computing device to filter DSG data for the first DSG capable computing device from the data; and
receive the DSG data from the second DSG capable computing device via the tunnel.

29. The system of claim 20, wherein to commit the first DSG capable computing device, the processor is further configured to:
complete DOCSIS registration of the first DSG capable computing device.

30. The system of claim 20, wherein to receive the DSG services, the processor is further configured to:
receive a notification from the second DSG capable computing device that the DSG services are available; and
receive a description of the DSG services from the second DSG capable computing device.

31. The system of claim 30, wherein the processor is further configured to:
send a request for the DSG services to the second DSG capable computing device.

32. The system of claim 20, wherein the second DSG capable computing device is a DSG proxy server.

33. The system of claim 20, wherein to request the establishment of the tunnel, the processor is further configured to:
request DCD data to confirm that the second DSG capable computing device supports DSG data forwarding; and
receive confirmation from the second DSG capable computing device of the establishment of the tunnel.

34. The system of claim 20, wherein the DSG data includes conditional access messages.

35. The system of claim 20, wherein the processor is further configured to:
receive a list of approved DHCP servers for the home network from the second DSG capable computing device.

36. A non-transitory computer-readable medium, comprising computer-executable instructions that, when executed on a first DSG capable computing device, perform steps of:
committing the first DSG capable computing device connected to a home network as a DSG proxy client;
receiving DSG services from a second DSG capable computing device connected to the home network, wherein the second DSG capable computing device includes a conditional access system that communicates data with the home network;
requesting establishment of a tunnel on the second DSG capable computing device to filter DSG data for the first DSG capable computing device from the data; and
receiving the DSG data from the second DSG capable computing device via the tunnel.
